(19) United States
(12) Patent Application Publication
(10) Pub. No.: US 2025/0130047 A1
(43) Pub. Date: Apr. 24, 2025

(54) STATION DEVICE FOR OUTPUTTING OPTIMAL ACTION TO PERSONS IN SEPARATE SPACE BASED SHOOTING SOUND DETECTION AND SYSTEM INCLUDING THE SAME

(71) Applicant: CORNERS CO., LTD., Seoul (KR)

(72) Inventors: Dong Oh KIM, Seoul (KR); Jang Won CHOI, Seoul (KR); Sungwon SHIN, Seoul (KR)

(73) Assignee: CORNERS CO., LTD., Seoul (KR)

(21) Appl. No.: 18/426,715

(22) Filed: Jan. 30, 2024

(30) Foreign Application Priority Data
Oct. 23, 2023 (KR) 10-2023-0141695

(51) Int. Cl. G01C 21/20; G06T 7/70; G06T 13/40; G06T 19/00

(52) U.S. Cl. CPC G01C 21/206; G06T 7/70; G06T 13/40; G06T 19/00; G06T 2207/30232

(57) ABSTRACT

Provided is a station device plurally provided to guide an action order responding to a gun accident to a user in a separate space, the station device including a microphone configured to detect a shooting sound in separate space; a communication unit configured to transmit a detection result of shooting sound to a server and to receive, from the server, a first occurrence location of first gun accident determined based on a detection result of first shooting sound detected by a first station device in separate space; an action determination unit configured to determine an action to be output by the station device in response to the first occurrence location using an action table in which an action to be output by the station device is mapped according to an occurrence location of a gun accident and a time; and an action output unit configured to output the determined action.

### CROSS-REFERENCE TO RELATED APPLICATION

This application claims the priority benefit of Korean Patent Application No. 10-2023-0141695, filed on Oct. 23, 2023, in the Korean Intellectual Property Office, the disclosure of which is incorporated herein by reference.

### BACKGROUND

### 1. Field of the Invention

The following example embodiments relate to a station device for outputting an optimal action to persons in a separate space (or compartmentalized space) based on shooting sound detection in the separate space and a plurality of station devices provided in the separate space.

### 2. Description of the Related Art

For occurrence of a shooting incident, the U.S. Interagency Security Committee (ISC) and the Federal Emergency Management Agency (FEMA) stipulate actions be taken in according with ‘RUN’ (active escape), ‘HIDE’ (hide), and ‘FIGHT’ (suppression). However, when a gun accident occurs, it is difficult for persons in an indoor space to understand a current situation and it is also difficult to convey specific behavioral know-how to them.

A conventional gunfire detection system refers to a system that estimates a location of a shooter using sound wave triangulation and notifies an administrator of the estimated location and is mainly used to estimate only the location of the shooter in an outdoor space or in a situation in which there is no information on the space. In particular, since the conventional gunfire detection system simply notifies the location of the shooter and does not provide information on how to respond, there was a limitation in reducing damage from a secondary gun accident.

A system and method for notifying the occurrence of accident is disclosed in Korean Patent Registration No. 10-1768639, registered on Aug. 30, 2017.

Information described above is provided to simply help understanding and may include contents that does not form a portion of the related art.

### SUMMARY

Example embodiments may provide a station device that may output an optimal action to a user in a separate space based on an occurrence location of a gun accident (e.g., a location of a shooter) verified based on a result of detecting shooting sound when the gun accident occurs in in the separate space, such as an indoor space, and a system using the station device.

Example embodiments may generate an action table used to determine an appropriate action to be output by a station device for each occurrence location of a gun accident and time zone based on a simulation that uses a three-dimensional (3D) model constructed for a separate space.

Example embodiments may provide a system that may simulate a gun accident in a separate space using a 3D model constructed for the separate space and allows a drill assuming the gun accident in the separate space to be performed in a similar manner to an actual situation.

According to an aspect, there is provided a station device plurally provided to guide an action order responding to a gun accident to a user in a separate space, the station device including a microphone configured to detect a shooting sound in the separate space; a communication unit configured to transmit a detection result of the shooting sound to a server and to receive, from the server, a first occurrence location of a first gun accident that is determined based on a detection result of a first shooting sound detected by a first station device in the separate space; an action determination unit configured to determine an action to be output by the station device in response to the received first occurrence location using an action table in which an action to be output by the station device is mapped according to an occurrence location of a gun accident and a time; and an action output unit configured to output the determined action, wherein the action includes guide information for the user to prepare for the first gun accident, and the action determination unit is configured to differently determine the action to be output by the station device over time by referring to the action table, and the action output unit is configured to output a different action over time.

By referring to the action table, the action determination unit may be configured to, when the station device is present within a possible escape location range for the separate space from the first occurrence location, determine a first action including first guide information for moving the user from a location of the station device to an exit location of the separate space as the action to be output by the station device, and when the station device is present in a dangerous location range from the first occurrence location, determine a second action including second guide information for moving the user from the location of the station device to a hide space in the separate space as the action to be output by the station device.

By referring to the action table, the action determination unit may be configured to determine the second action as the action to be output by the station device over time after determining the first action as the action to be output by the station device, and the action output unit may be configured to output the second action over time after outputting the first action.

The action determination unit may be configured to determine that the action output unit outputs an inactive action not including the guide information i) if a predetermined period of time elapses during which a shooter of the first gun accident is estimated to pass the location of the station device, or ii) if the first occurrence location is within a predetermined distance from the location of the station device.

By referring to the action table, the action determination unit may be configured to determine the second action including the second guide information as the action to be output by the station device when the station device is present at or around a line-of-sight (LoS) location associated with the first occurrence location.

When the communication unit receives, from the server, a second occurrence location of the first gun accident determined based on a detection result of a second shooting sound after the first shooting sound detected by a second station device in the separate space or the second occurrence location that is a location of a shooter of the first gun accident detected by a surveillance camera or a sensor provided in the separate space, the action determination unit may be configured to determine the action to be output by the station device in response to the second occurrence location using the action table.

The communication unit may be configured to communicate with the server through a repeater provided in the separate space, the server may be a cloud server located outside the separate space, and content including the guide information may be provided to a terminal of the user based on communication between the communication unit and the server.

The action table may be generated by a method including the following operations and stored in the station device, and the method may include acquiring a three-dimensional (3D) map of the separate space; specifying a plurality of nodes for the 3D map and an arc that connects two of the nodes, at least one node among the nodes being specified as an exit node for the separate space and each station device among the plurality of station devices being associated with one of the nodes; specifying at least one hide space within the 3D map; placing at least one shooter in at least one node among the nodes and simulating a movement of the shooter on the 3D map; determining a first optimal route from a node corresponding to each station device to the exit node and a second optimal route from the node corresponding to each station device to the hide space; and generating the action table based on a simulation result, the first optimal route, and the second optimal route.

The simulating may include determining a dangerous location range and a possible escape location range for the separate space on the 3D map based on a node corresponding to a location of the shooter according to a movement of the shooter.

The method may further include specifying at least one LoS point within the 3D map, and the determining the dangerous location range and the possible escape location range for the separate space may include determining that a node or an arc on a LoS of the shooter falls within the dangerous location range when the shooter is located in the node associated with the LoS point.

According to some example embodiments, when a gun accident occurs in an indoor space, a station device may determine and output an appropriate action for a user in a separate space using only location information received (e.g., broadcasted) from a server through an action table stored in the station device. Therefore, it is possible to minimize delay between occurrence of the gun accident, that is, occurrence of shooting sound and output of the action.

According to some example embodiments, when a gun accident occurs in an indoor space, it is possible to safely evacuate or hide a user by identifying an occurrence location of the gun accident or a location of a shooter and by outputting an appropriate action to the user in a separate space.

According to some example embodiments, it is possible to minimize damage from occurrence of a gun accident by guiding a hide order to indoor personnel located close to a shooter or on a line of sight (LoS) of the shooter.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates a concept of minimizing damage by transmitting an action order to indoor personnel when a gun accident occurs in a separate space.

FIG. 2 illustrates a system for detecting a shooting sound caused by a gun accident, verifying a location of the gun accident, and outputting an appropriate action to a user in a separate space according to an example embodiment;

FIG. 3 is a diagram illustrating a station device to receive location information associated with a gun accident from a server and to determine an action to be output for a user according to an example embodiment;

FIG. 4 illustrates a repeater and a server to relay communication between the server and a station device according to an example embodiment;

FIGS. 5 to 7 illustrate a station device to determine and output an appropriate action for a user when a gun accident occurs according to an example;

FIG. 8 illustrates an action table used to determine an appropriate action to be output for a user when a gun accident occurs according to an example;

FIG. 9 illustrates a method of determining an appropriate action to be output for a user when a gun accident occurs using an action table according to an example;

FIG. 10 is a flowchart illustrating a method of generating an action table used to determine an appropriate action to be output for a user according to an example embodiment;

FIG. 11 is a flowchart illustrating a method of simulating a gun accident in a separate space according to an example;

FIG. 12 illustrates a three-dimensional (3D) model for a separate space according to an example;

FIG. 13 illustrates a method of placing station device(s) in a 3D model of a separate space according to an example;

FIGS. 14 and 15 illustrate a method of simulating a gun accident in a 3D model of a separate space according to an example;

FIG. 16 illustrates a method of assigning a gun accident scenario to a shooter virtually placed in a 3D model of a separate space according to an example;

FIGS. 17 and 18 illustrate an operation of a station device when a gun accident occurs or during a training (i.e., drill) assuming the gun accident according to an example;

FIG. 19 illustrates a screen of an administrator terminal during a drill assuming a gun accident according to an example; and

FIG. 20 illustrates a screen of an administrator terminal when a gun accident occurs according to an example.

### DETAILED DESCRIPTION

Hereinafter, example embodiments will be described with reference to the accompanying drawings. Like reference numerals illustrated in each drawing refer to like elements throughout.

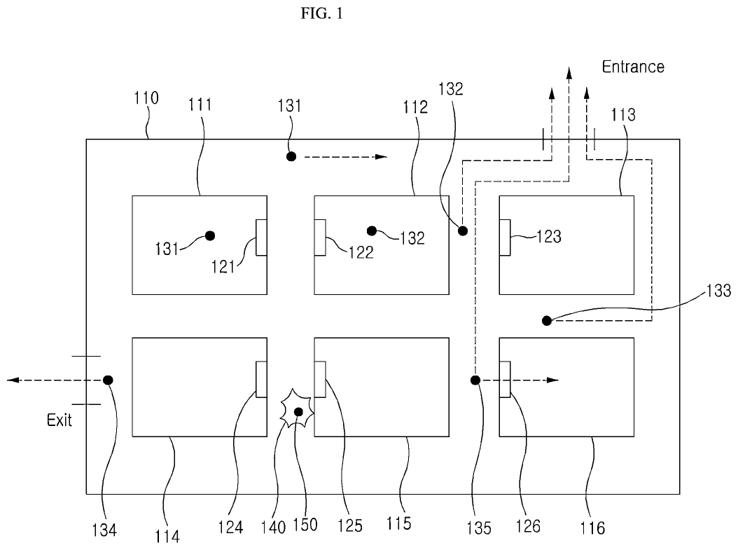

FIG. 1 illustrates a concept of minimizing damage by transmitting an action order to indoor personnel when a gun accident occurs in a separate space.

FIG. 1 illustrates a separate space 110. The separate space 110 may be, for example, an indoor space, an outdoor space, or a complex space in which the indoor space and the outdoor space are combined.

The separate space 110 may be divided into a plurality of internal spaces 111, 112, 113, 114, 115, and 116 using structures. Each of the internal space 111, 112, 113, 114, 115, and 116 may be an individual separate space, for example, a space such as a room and a partition. Referring to FIG. 1, a plurality of persons 131, 132, 133, 134, 135, 136, and 137 (hereinafter, also referred to as users (131 to 137) may be located in the separate space 110. The internal spaces 111, 112, 113, 114, 115, and 116 may be configured to be accessible through structures, such as entrance doors 121, 122, 123, 124, 125, and 126.

It may be assumed that a gun accident 140 has occurred inside the separate space 110. The gun accident 140 occurs when a shooter 150 shoots a firearm at another person and is usually accompanied by a shooting sound.

In an example embodiment, by placing a plurality of station devices (not shown in FIG. 1) that detects the shooting sound in the separate space 110 and outputs an appropriate action to the users 131 to 137, the users 131 to 137 may hide in the separate space 110 and may escape from the separate space 110. The station devices placed in the separate space 110 may be configured to output an action including guide information that represents an optimal escape route (i.e., escape route to entrance of the separate space 110) or guide information including a movement and a hide order to a hide space to the users 131 to 137, by consideration a verified location of the gun accident 140 or the shooter 150. Through this, a secondary accident by the shooter 150 may be prevented.

A station device present at a location associated with a user close to a location of the gun accident 140 or the shooter 150 among the users 131 to 137 may output an action representing a hide order (or an optimal route for hide) (to avoid being exposed to the shooter 150). A station device present at a location associated with a user far from the location of the gun accident 140 or the shooter 150 among the users 131 to 137 may output an action representing an evacuation order (or an optimal route for evacuation) (to deviate from the separate space 110). Meanwhile, although a corresponding user is far from the location of the gun accident 140 or the shooter 150, the station device may output the action representing the hide order rather than the action representing the evacuation order to the user located on or around the LOS of the shooter 150, to prevent occurrence of the secondary gun accident.

As described above, a gun accident response guidance system that is a system of an example embodiment may include a plurality of station devices and each station device may include a microphone configured to detect a shooting sound to estimate an occurrence location of the gun accident 140 and an action output unit configured to output an appropriate action. The system may include a server and each station may receive a location of the gun accident 140 or the shooter 150 from the server and may output an appropriate action to the user in the separate space 110.

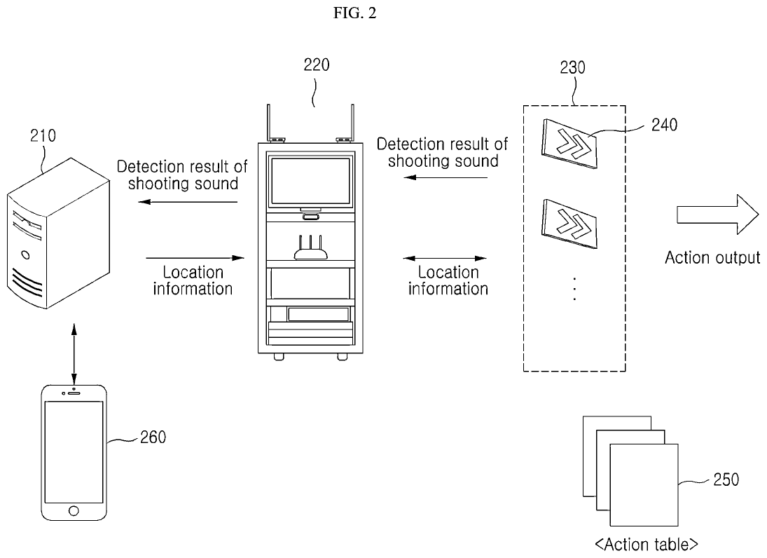

A structure and an operation of a station device and a system including the station device are further described below with reference to FIGS. 2 to 20.

FIG. 2 illustrates a system for detecting a shooting sound caused by a gun accident, verifying a location of the gun accident, and outputting an appropriate action to a user in the separate space according to an example embodiment.

FIG. 2 illustrates a plurality of station devices 230 placed in the separate space 110. Reference numeral 240 is assigned to each station device. The station device 240 may receive location information from a server 210 and may output an appropriate action to the users 131 to 137 (hereinafter, reference numerals may be omitted) in the separate space 110 based on the corresponding location information. Here, a station device that detects a shooting sound among the station devices 230 may transmit a detection result of the corresponding shooting sound to the server 210 and the station device 240 may receive location information determined according thereto.

Meanwhile, the station devices 230 may communicate with the server 210 in a wireless and/or wired manner through a repeater 220. For example, the repeater 220 may be configured to include a module for long range (LoRa) communication. The repeater 220 may relay communication between the station devices 230 and the server 210 through LoRa communication.

The station devices 230, the server 210, and the repeater 220 may configure the aforementioned system (gun accident response guidance system).

Here, the server 210 may be a server placed inside the separate space 110, or may be a cloud server placed outside the separate space 110 depending on example embodiments. When the server 210 is the cloud server, the gun accident response guidance system may be established for the separate space 110 simply by installing the station devices 230 and the repeater 220 in the separate space 110.

The server 210 may be constructed as at least one computer system and further description related thereto is made below.

For clarity of description, a station device that detects a shooting sound by the gun accident 140 is referred to as a first station device and a station device that outputs an appropriate action based on location information received from the server 210 is referred to as the station device 240.

Detection of the shooting sound may be performed in such a manner that a model constructed based on a result of learning a plurality of pieces of shooting sound data is mounted to the station device 240. Such learning may be performed using a pattern recognition algorithm, a deep learning algorithm, and the like.

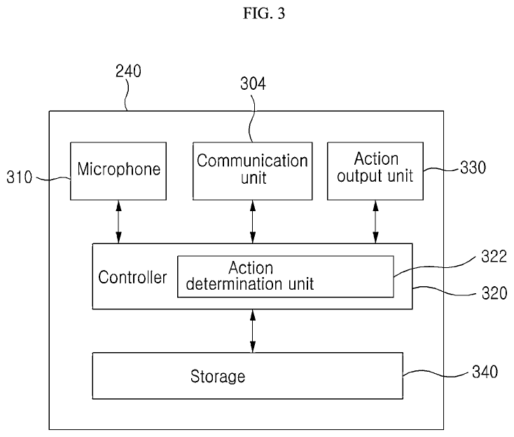

In this regard, FIG. 3 illustrates the station device 240 configured to receive location information associated with the gun accident 140 from the server 210 and to determine and output an action to be output for a user.

As described above, the plurality of station devices 230 may be provided in the separate space 110 and may be configured to guide an action order responding to the gun accident 140 to a user in the separate space 110.

Referring to FIG. 3, the station device 240 may include a microphone 310 configured to detect a shooting sound associated with the gun accident 140 in the separate space 110 and a communication unit 304 configured to transmit a detection result of the shooting sound to the server 210 and to receive, from the server 210, a first occurrence location of a first gun accident that is determined based on a detection result of a first shooting sound by a first station device in the separate space 110. Depending on cases, the first station may be the same as the station device 240. Alternatively, the first station device may be placed at a location different from that of the station device 240.

The communication unit 304 may be a component to receive location information from the server 210 through communication with the repeater 220 and to transmit data, such as a detection result of the shooting sound, to the server 210. That is, the communication unit 304 may be a component for the station device 240 to transmit/receive data and/or information to/from other different devices, such as the server 210, through the repeater 220. The communication unit 304 may be a hardware module, such as a network interface card, a network interface chip, and a networking interface port of the station device 240, or a software module, such as a network device driver or a networking program. For example, the communication unit 304 may include a module for LoRa communication.

The station device 240 may include a controller 320 configured to manage and control components included in the station device 240. The control unit 320 may include at least one processor to perform a simple operation or at least one processor to perform a complex operation. The processor may be configured to execute a program or an application used by the station device 240. The processor may be at least one core within a processor of the station device 240.

Meanwhile, the station device 240 may include an action output unit 330 configured to output an appropriate action for a user and an action determination unit 322 configured to determine the appropriate action to be output to the user. The action determination unit 322 may be a component included in the control unit 320. Also, the station device 240 may include a storage 340 configured to store data necessary for determining and outputting the action. The storage 340 may include at least one memory and/or storage.

The station device 240 operate through a wireless power source and, additionally, may be connected to a constant power source for operation in an emergency.

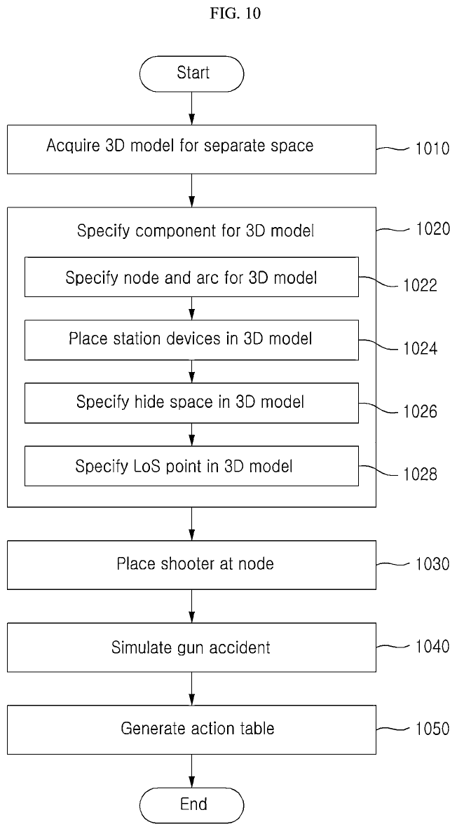

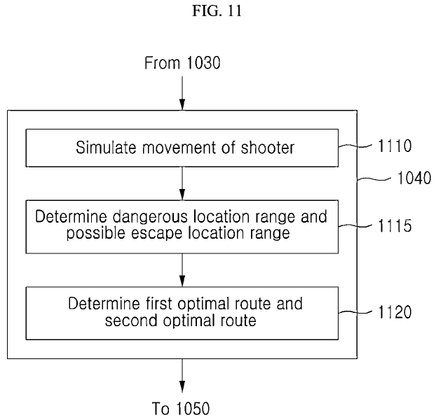

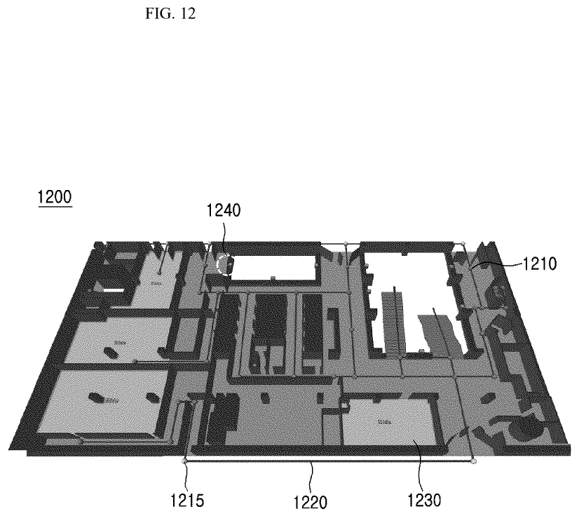

In an example embodiment, the action determination unit 322 may determine the action to be output by the station device 240 in response to a first occurrence location of a first gun accident received from the server 210, using an action table 250 of FIG. 2. Therefore, the action output unit 330 may output the determined action. Here, the action table 250 may be a table in which the action to be output by the station device 240 is mapped according to an occurrence location of the gun accident 140 and time. The action table 250 may be predetermined and stored in the storage 340. A method (algorithm) of generating the action table 250 is further described below with reference to FIGS. 10 and 11.

The action determination unit 322 may determine an action mapped to the first occurrence location (corresponding to an occurrence location of the first gun accident or a location of a shooter of the first gun accident) using the action table 250, as the action to be output by the station device 240.

The action that is determined and output may include guide information to prepare for the first gun accident for the user.

Meanwhile, the action determination unit 322 may be configured to differently determine the action to be output by the station device 240 over time by referring to the action table 250. Therefore, the action output unit 330 may be configured to output a different action over time. That is, in the action table 250, an action to be output by the station device 240 according to an occurrence location of a gun accident may be mapped for each time zone (time range). The determined and output action may be, for example, one of the aforementioned evacuation order and hide order.

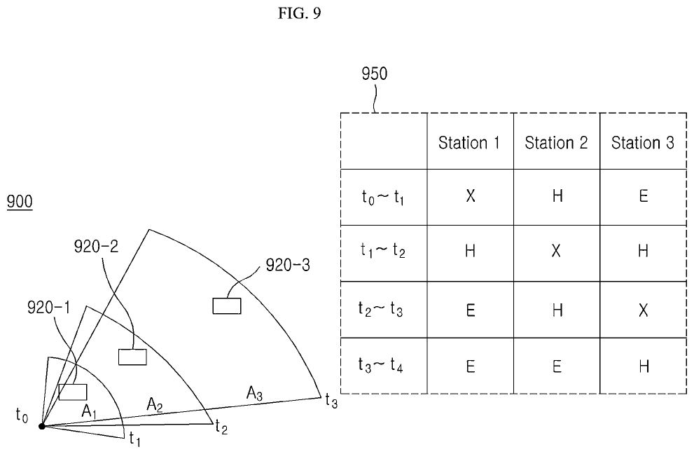

A method of determining an action using the action table 250 is further described below with reference to FIGS. 8 and 9.

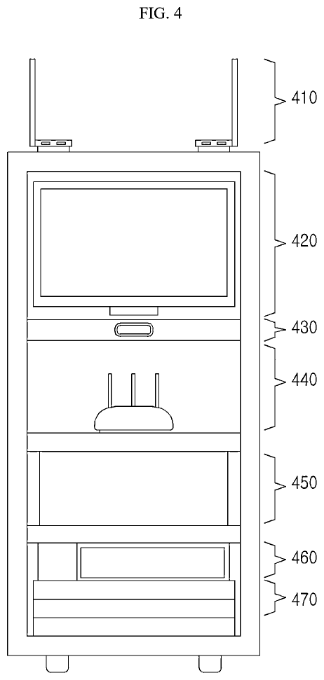

Meanwhile, FIG. 4 illustrates a repeater and a server to relay communication between the server and a station device according to an example embodiment.

FIG. 4 illustrates a device that includes a gateway unit 410 corresponding to the repeater 220 of FIG. 2 and a server unit 450 corresponding to the server 210. The gateway unit 410 may be a LoRa wireless gateway and may include a plurality of channels. Each channel may communicate with a predetermined number of station devices 230. The server unit 450 may represent an example of the server 210 present in the separate space 110 rather than a cloud server.

The device of FIG. 4 may further include a monitor 420 configured to monitor a situation in the separate space 110 and an I/O device 430, for example, a keyboard/mouse. Also, the device may further include a router 440 configured to support wireless and/or wired communication. Also, the device may further include an uninterruptible power supply (UPS) and UPS battery packs 460 and 470 configured to supply power. As illustrated, components (410 to 470) of the device may be received in a rack.

The monitor 420 may display a screen captured by a closed-circuit television (CCTV) in the separate space 110, may display a simulation of a gun accident on a 3D model of the separate space 110 by displaying the 3D model to be described below, or may display a user interface provided from a builder for gun accident modeling for the 3D model.

Meanwhile, the server 210 may be configured as a computer system and, although not illustrated, may include a communication unit and a processor for communication with the repeater 220. The aforementioned description may be applied similarly to the communication unit and the processor and thus, repeated description is omitted.

The server 210 may receive a detection result of first shooting sound according to the first shooting sound detected by a first station device and accordingly, determine a first occurrence location of a first gun accident associated with the first shooting sound. The detection result transmitted to the server 210 may include an identifier of the first station device. Here, the first occurrence location may represent a location of a shooter of the first gun accident. The server 210 may transmit the determined first occurrence location to the station device 240. For example, the server 210 may broadcast the first occurrence location to the station devices 230 that include the station device 240.

The first occurrence location may represent a location of the first station device, and may include a location of the first station device in the separate space 110 and/or an identifier of the first station device.

When the first shooting sound is detected by a plurality of station devices including the first station device and detection results of the plurality of first shooting sounds are received by the station devices, the server 210 may determine a station device (herein, the first station device) with a largest magnitude (dB) of shooting sound represented by a corresponding detection result as a first occurrence location of the first gun accident.

Therefore, depending on example embodiments, the server 210 may transmit the first occurrence location to the station device 240, and the station device 240 may determine an appropriate action to be output based on the first occurrence location by referring to the action table 250, without performing a complex arithmetic operation. As such, according to an example embodiment, delay from the occurrence of the first gun accident to decision and output of the action may be minimized, which may lead to minimizing damage by the first gun accident.

Also, in an example embodiment, content including guide information may be provided to a terminal 260 of the user (in the separate space 110 that receives the output action), based on communication between the station device 240 (communication unit 304) and the server 210. Here, the guide information may include description related to the gun accident that occurred in the separate space 110, information on a hide space or an evacuation route in the separate space 110, an alarm, and a code of action according to occurrence of the gun accident. The terminal 260 may include, for example, a smartphone, a tablet, an Internet of things (IoT) device, and a wearable computer.

Technical features described above with reference to FIG. 1 may be applied as is to FIGS. 2 to 4 and thus, repeated description is omitted.

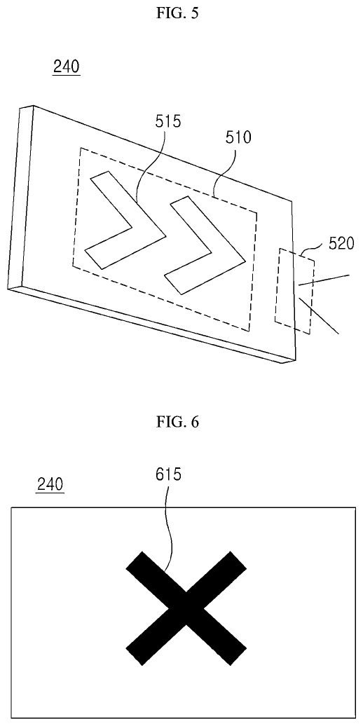

FIGS. 5 to 7 illustrate a station device to determine and output an appropriate action for a user when a gun accident occurs according to an example.

An action output by the station device 240 is further described with reference to FIGS. 5 to 7.

As described above with reference to FIG. 2, the action determination unit 322 may determine an action mapped to the first occurrence location (corresponding to an occurrence location of the first gun accident or a location of the shooter of the first gun accident) as the action to be output by the station device 240 by referring to the action table 250. Here, the action that is determined and output may include guide information for the user to prepare for the first gun accident.

Meanwhile, the action determination unit 322 may differently determine the action to be output by the station device 240 over time by referring to the action table 250. That is, the action determination unit 322 may differently determine the action to be output based on a location of the shooter of the first gun accident that is estimated over time in consideration of a period of time elapsed from a time at which the first occurrence location is received (or transmitted).

That is, in the action table 250, an action to be output by the station device 240 according to an occurrence location of a gun accident may be mapped for each time zone. The action determination unit 322 may differently determine the action to be output for each time zone by referring to the action table 250. The determined and output action may be, for example, one of the evacuation order and the hide order.

For example, when the station device 240 is within a possible escape location range from the first occurrence location in the separate space 240, the action determination unit 322 may determine a first action including first guide information for moving the user from a location of the station device 240 to an exit location of the separate space 110 as the action to be output by the station device, by referring to the action table 250. The first action may correspond to the aforementioned evacuation order.

On other hand, when the station device 240 is within a dangerous location range from the first occurrence location, the action determination unit 322 may determine a second action including second guide information for moving the user from the location of the station device 240 to a hide space in the separate space 110 as the action to be output by the station device 240, by referring to the action table 250. The second action may correspond to the aforementioned hide order.

Whether the station device 240 is within the possible escape location range or within the dangerous location range may be determined based on a distance between the first occurrence location and the location of the station device 240 and a period of time elapsed from a time at which the first occurrence location is received (or transmitted) and may be determined by referring to the action table 250 in which relevant values are mapped.

When the first occurrence location is close to the station device 240 or when it is predicted that the first occurrence location and the station device 240 have become closer over time (as the shooter moves), the station device 240 may determine the second action as the action to be output. Alternatively, when the first occurrence location is far from the station device 240 or when it is predicted that the first occurrence location and the station device 240 have become distant over time (as the shooter moves), the station device 240 may determine the first action as the action to be output. Here, decision of the action may be performed by referring to the action table 250.

For example, by referring to the action table 250, the action determination unit 322 may determine the second action as the action to be output by the station device 240 over time after determining the first action as the action to be output by the station device 240. Accordingly, the action output unit 330 may output the second action over time after outputting the first action. That is, although the action output unit 330 initially outputs an action corresponding to “evacuation order” due to a distant distance between the first occurrence location and the location of the station device 240, the action output unit 330 may output an action corresponding to “hide order” after a predetermined period of time elapses since it is predicted that the shooter will become close to the station device 240 over time. Here, the predetermined period of time may be a value that is determined based on the shooter's movement speed and/or movement range and may be included in the action table 250.

FIG. 5 illustrates an example of outputting, by the station device 240, a first indicator 515 (or 510) corresponding to the first action. The action output unit 330 of the station device 240 may include a display configured to output a visual indicator, the first indicator 515, and may also further include at least one light source 520 (light emitting diode (LED), etc.) configured to output light to an outside.

The first indicator 515 may be configured to display a route and/or movement direction (up, down, left, right) through which the user needs to evacuate. The light source 520 may be configured to indicate the corresponding route and/or movement direction through an LED beam. The user that verifies the first indicator 515 may intuitively figure out a direction to move when a gun accident occurs.

Meanwhile, the first indicator 515 may correspond to the second action. In this case, the first indicator 515 may represent a route and/or a movement direction to a hide space. The first indicator 515 corresponding to the first action and the first indicator 515 corresponding to the second action may be visually distinguished by color and/or other forms.

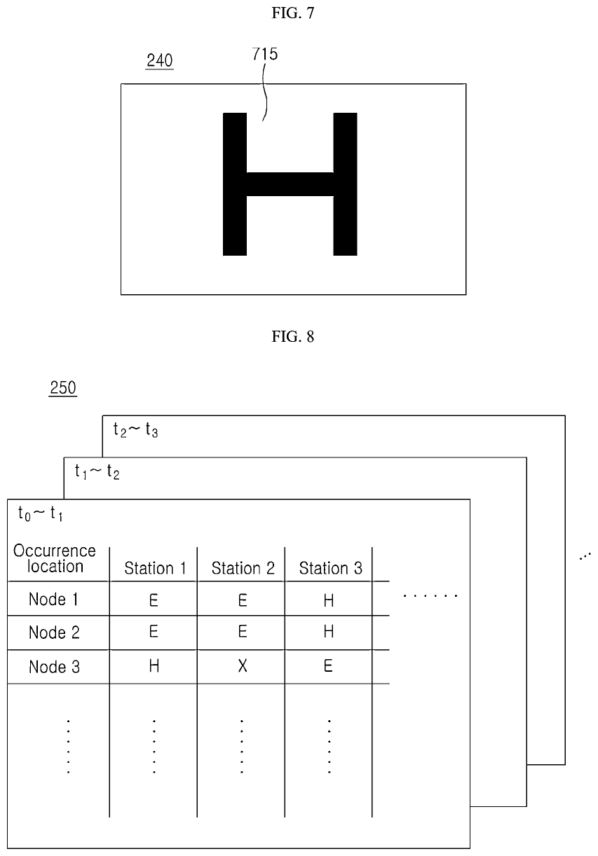

Alternatively, as illustrated in FIG. 7, the second action may be output in a form of a third indicator 715 that is distinct from the first indicator 515. The third indicator 715 may be an indicator that indicates hiding in a surrounding hide space. The route and/or the movement direction to the hide space may be indicated through the light source 520.

Also, although not illustrated, the station device 240 may further include a speaker configured to output voice or alert sound corresponding to the first action and the second action.

Additionally, the action determination unit 322 may determine that the action output unit 330 outputs an inactive action not including the guide information i) if a predetermined period of time elapses during which a shooter of the first gun accident is estimated to pass the location of the station device 240, or ii) if the first occurrence location is within a predetermined distance from the location of the station device 240. Here, the predetermined period of time may be a value that is determined based on the shooter's movement speed and/or movement range, which are known values, and may be included in the action table 250. That is, if the shooter and the station device 240 are close, the station device 240 may prevent the shooter from identifying the evacuation order and the hide order exposed by the station device 240. Therefore, the shooter may not acquire any information on the user through the station device 240.

FIG. 6 illustrates an example in which the station device 240 outputs a second indicator 615 corresponding to the inactive action. The second indicator 615 may be distinguished from the aforementioned first and third indicator 515 and 715 by color and/or shape.

As described above, in an example embodiment, by using the action table 250 in which an appropriate action to be output by the station device 240 according to an occurrence location of a gun accident and over time after an occurrence time of the gun accident is mapped, an appropriate action suitable for a situation of the gun accident may be determined and the determined action may be output through a visual indicator.

Technical features described above with reference to FIGS. 1 to 4 may be applied as is to FIGS. 5 to 7 and thus, repeated description is omitted.

Hereinafter, a method of determining an appropriate action to be output by the station device 240 using the action table 250 is further described.

FIG. 8 illustrates an action table used to determine an appropriate action to be output for a user when a gun accident occurs according to an example.

As illustrated, in the action table 250, an action to be output by each station device may be mapped to an occurrence location of the gun accident. Here, E may correspond to an action corresponding to an evacuation order, H may correspond to an action corresponding to a hide order, and X may correspond to an inactive action.

The occurrence location refers to a node in which the gun accident is estimated have occurred and may represent a node indicating the occurrence location or a node in which a station device associated with the occurrence location is present.

In the action table 250, an action to be output by a corresponding station device at the occurrence location may be mapped for each time zone (t₀ to t₁). Therefore, the action determination unit 322 may determine an appropriate action to be output by considering a movement of a shooter over time.

Meanwhile, FIG. 9 illustrates a method of determining an appropriate action to be output for a user when a gun accident occurs using an action table according to an example.

In the illustrated example, a method of determining, by the action determination unit 322, an appropriate action to be output by referring to an action table 950 when three station devices 920-1, 920-2, and 920-3 are placed in a separate space 900 is described.

Referring to FIG. 9, a first area (A₁) may represent a range in which the shooter may move during a first time zone (t₀ to t₁), a second area (A₂) may represent a range in which the shooter may move during a second time zone (t₁ to t₂), and a third area (A₃) may represent a range in which the shooter may move during a third time zone (t₂ to t₃).

The movable range and the time zone may be values that are determined based on the shooter's movement speed and/or movement range, which are known values.

By referring to the action table 950, the action determination unit 322 of the station device 920-1 may output X (inactive action) since the shooter is very close in the first time zone from a point in time at which a location of the shooter is initially specified, may output H (hide order) since the shooter is close in the second time zone, and may output E (evacuation order) since the shooter is far away in the third time zone.

Likewise, by referring to the action table 950, the action determination unit 322 of the station device 920-2 may output H (hide order) since the shooter is close in the first time zone from a point in time at which the location of the shooter is initially specified, may output X (inactive action) since the shooter is very close in the second time zone, and may output H (hide order) since the shooter is close in the third time zone.

Likewise, by referring to the action table 950, the action determination unit 322 of the station device 920-3 may output E (evacuation order) since the shooter is far away in the first time zone from a point in time at which the location of the shooter is initially specified, may output H (hide order) since the shooter is close in the second time zone, and may output X (inactive action) since the shooter is very close in the third time zone.

As described above, each of the station devices 920-1, 920-2, and 920-3 may determine and output an appropriate action over time by referring to the action table 950.

Meanwhile, in the case of a gun accident, a shooting sound may not stop at one time and additional secondary shooting sound (i.e., subsequent shooting) may occur after occurrence of primary shooting sound.

Here, the station device 240 (communication unit 304) may receive, from the server 210, a second occurrence location of the first gun accident that is determined based on a detection result of a second shooting sound (after the first shooting sound) detected by a second station device in the separate space. The aforementioned description related to the first station device and reception of the first occurrence location may be applied similarly to the second station and reception of the second occurrence location and thus, repeated description is omitted. Meanwhile, in another example embodiment, the second occurrence location may be received from the server 210 as an additional location of the shooter of the first gun accident detected by a surveillance camera or a sensor provided in the separate space 110. The surveillance camera(s) may be disposed on the location(s) of the separate space 110 independently from the station devices.

In other words, the shooter may be identified by further using the surveillance cameras disposed on the separate space 110 independently from the station. Thus, the location of the shooter is not simply determined based on the shooting sound, but is determined more accurately by further utilizing the surveillance cameras, which are placed for various purposes within the separate space 110. Additionally, the surveillance cameras may detect the locations of the shooter in areas of the separate space 110 not to be able to be detected by using the stations.

When the second occurrence location is received for the station device 240, the action determination unit 322 may determine an action to be output by referring to the action table 250, 800, 950 based on the second occurrence location. That is, the action determination unit 322 may determine an action to be output by the station device 240 using the action table 250, 800, 950, in response to the second occurrence location. The determined action may vary according to a time zone after the second occurrence location is received (transmitted).

As described above, in an example embodiment, an action to be output by the station device 240 may be determined based on a more accurate occurrence location of a gun accident that is determined by subsequent shooting or more accurate location recognition of the shooter.

Also, each mapped value of the action table 800, 950 may include location information associated with a corresponding action or may further refer to location information. Accordingly, the output action may represent an optimal route (direction of the optimal route for evacuation/hide) along which the user needs to move.

Technical features described above with reference to FIGS. 1 to 7 may be applied as is to FIGS. 8 and 9 and thus, repeated description is omitted.

FIG. 10 is a flowchart illustrating a method of generating an action table used to determine an appropriate action to be output for a user according to an example embodiment.

A method (algorithm) of generating the action table 250 is further described with reference to FIG. 10.

The action table 250 may be generated based on a result of modeling a movement and a behavior of at least one virtual shooter at every location of the separate space 110. That is, when the shooter is located at a random location of the separate space 110, the action table 250 may be generated by learning an optimal action (evacuation order (evacuation route), hide order, etc.) to be output for the user located at the random location of the separate space 110. Such learning may be performed using an artificial intelligence (AI) algorithm, such as a reinforcement learning algorithm and a deep learning algorithm.

Generation of the action table 250 may be performed by the server 210 or the server unit 450 that executes a builder, and may also be performed through a terminal of an administrator that controls the server 210 or the server unit 450. Alternatively, generation of the action table 250 may be performed through a separate computer system that executes the builder.

In other words, the action table 250 is generated based on the results of modeling the movement and behavior of at least one virtual shooter at all positions (e.g., nodes) in the separate space, and action table 250 is generated using an artificial intelligence algorithm learning an action to be output for the user located at any position (node) in the separate space when the virtual shooter is positioned at any position in the separate space.

It will be described that the following operations are performed by the computer system collectively naming the devices.

In operation 1010, the computer system may acquire a 3D model of the separate space 110. The 3D model may be a 3D map as 3D space modeling data for the separate space 110. The 3D map may include internal space(s) included in the separate space 110 and facilities (entrance, exit, door, etc.) placed in the separate space 110. The 3D model may be generated based on a two-dimensional (2D) map for the separate space 110 or 3D scanning for the separate space 110.

In operation 1020, the computer system may specify components for the 3D model (hereinafter, referred to as 3D map for clarity of description).

In operation 1022, the computer system may specify a plurality of nodes for the 3D map and an arc that connects two of the nodes. At least one of the nodes may be specified as an exit node (or entrance node) for the separate space 110. That is, a general node and the exit node may be distinguishably specified.

In operation 1024, the computer system may place the plurality of stations devices 230 in the 3D map. Each station device may be placed at an appropriate location, such as an entrance of an indoor space, inside the indoor space, hallway, staircase, and the like. Each station device may be associated with one of the nodes. That is, each station device may be mapped for a single node.

In operation 1026, the computer system may specify at least one hide space for the 3D map. The hide space may be set as at least a portion of the indoor space included in the separate space 110. The hide space may include a plurality of nodes.

In operation 1028, the computer system may specify at least one LoS point in the 3D map. The LoS point may be mapped to a node or may be specified in the 3D map separate from the node. The LoS point may be used to consider a LoS of the shooter when the shooter is located at a location (node) associated with the corresponding LoS point. The LoS point may be placed at a location at which the shooter is likely to view and shoot from a distance, such as a window, hallway, staircase, and an open area downward or upward indoors.

The LoS point may be used to determine that a node or an arc on the LoS of the shooter falls within the aforementioned dangerous location range when the shooter is located in the node associated with the LoS point.

In this regard, FIG. 12 illustrates a 3D model for a separate space according to an example.

Referring to FIG. 12, a plurality of nodes may be specified in a separate space 1200. The nodes may include a general node 1210 in red (e.g., a first color) and an exit node 1215 in green (e.g., a second color). The nodes may be connected through an arc (or link) 1220. Some areas of the separate space 1200 may be specified as hide spaces (hide). As illustrated in an area outlined in the dotted lines, at least one virtual point 1240 may be placed in the separate space 1200. The virtual point 1240 may be placed at a downward or upward open location of the separate space 1200.

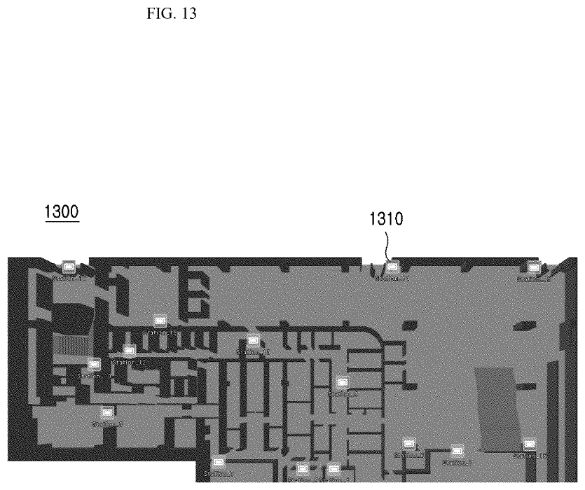

Meanwhile, FIG. 13 illustrates a method of placing station device(s) in a 3D model of a separate space according to an example.

As illustrated, a plurality of station devices 1310 may be placed in a separate space 1300. Each of the station devices 1310 may be mapped to a node.

When specification of components is completed in the 3D map in operation 1020, the computer system may place at least one shooter in at least one node among the nodes in operation 1030 and may simulate a movement of the placed shooter in operation 1040. For example, the computer system may model a movement and a behavior of the shooter in the 3D map by placing a predetermined number of virtual shooters at a random node. Alternatively, locations and the number of shooters placed may be determined by the administrator.

When the shooter is located at a random location of the separate space 1200, 1300 through the simulation, the computer system may learn an optimal action (evacuation order (evacuation route), hide order, etc.) to be output for a user located at the random location of the separate space 1200, 1300. Such learning may be performed using an AI algorithm, such as a reinforcement learning algorithm and a deep learning algorithm.

In operation 1050, the computer system may generate the action table 250 based on a simulation result of the gun accident in operation 1040.

In this regard, the simulation of the gun accident is further described with reference to FIG. 11.

FIG. 11 is a flowchart illustrating a method of simulating a gun accident in a separate space according to an example.

In an example embodiment, through the simulation of the gun accident, a potential movement route and range of the shooter may be verified in the separate space 1200, 1300 over time and an optimal evacuation or hide route of the user in the separate space 1200, 1300 may be determined accordingly.

In operation 1110, the computer system may simulate a movement of (e.g., randomly placed) at least one shooter. The shooter may be set to act according to a random scenario or may be set to act according to a scenario specified by the administrator.

In operation 1120, the computer system may determine a first optimal route from a node corresponding to each station device to an exit node and a second optimal route from a node corresponding to each station device to the hide space. That is, the computer system may verify a potential movement route and range of the shooter over time and may determine the first optimal route and the second optimal route.

The computer system may generate the action table 250 based on the simulation result, the first optimal route, and the second optimal route.

That is, the simulation may be a process of determining an optimal action (guide information) to be performed at a location of each node with the assumption that the shooter may be located at every node.

Using the artificial intelligent algorithm, the computer system may determine the first optimal route and the second optimal route based on the learning results of the learning model of the artificial intelligent algorithm in which an action to be output for the user located at any position (node) in the separate space is learned when the virtual shooter is positioned at any position in the separate space.

Meanwhile, in the simulation, as in operation 1115, the computer system may determine a dangerous location range and a possible escape location range for a separate space in the 3D map based on a node corresponding to a location of the shooter according to a movement of the shooter. If a station device is in the dangerous location range of the shooter, the corresponding station device may output a hide order (here, output an inactive action if the station device and the shooter are too close). If the station device is in the possible escape location range of the shooter, the corresponding station device may output an evacuation order.

The dangerous location range may represent a space range within a predetermined range from the location of the shooter. For example, the dangerous location range may represent a space range in which the shooter may move during a predetermined period of time. The possible escape location range may refer to a space range suitable for evacuation or escape rather than hide from the shooter and may represent the space range other than the dangerous location range.

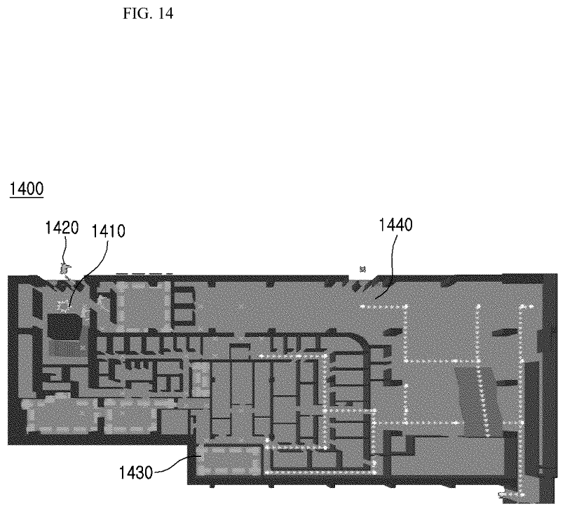

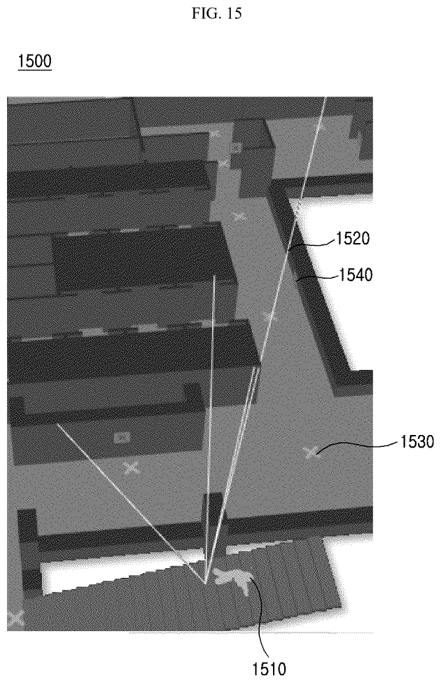

In this regard, FIGS. 14 and 15 illustrate a method of simulating a gun accident in a 3D model of a separate space according to an example

In FIG. 14, three virtual shooters 1420 are placed at an occurrence location 1410 of a gun accident. A dangerous location range by the shooters 1420 are illustrated as areas 1430 in a third color. Meanwhile, a possible escape location range is illustrated as a remaining area (i.e., an area that includes an optimal route 1440 in a forth color). The optimal route 1440 may represent a route for escaping from the separate space 1400 and a direction indicating the optimal route 1440 may be output from a station device placed in the possible escape location range.

FIG. 15 illustrates a case in which a virtual shooter 1510 is placed at a location associated with a LoS point. A node 1530 is marked in a fifth color. A LoS 1520 of the shooter 1510 indicated with solid lines. A center point at which lines of sight converge may be a location at which the LoS point is placed. As illustrated, station devices around the shooter 1510 may output red (or sixth colored) X that is an inactive action. Also, when located above the LoS 1520 or close to the LoS 1520, a station device 1540 that is relatively far away from the shooter may output red X that is an inactive action. Meanwhile, the LoS 1520 may include at least one point on an area of the separate space opened upward or downward from an occurrence location of the accident or a location of the shooter (or a node corresponding to the occurrence location or location of the shooter) the determined on the 3D map of the separate space. Thus, the LoS 1520 may be set to cover 3D area.

Therefore, the LoS point may be used to determine that a node or an arc on the LoS 1520 of the shooter 1510 falls within the aforementioned dangerous location range when the shooter 1510 is located in a node associated with the LoS point.

Information on the LoS point may be included in the action table 250, 800, 950. Regardless of time elapse or a time zone, when the station device 240 is located at or around the LoS location associated with the aforementioned first occurrence location, the action determination unit 322 may determine a second action (or inactive action) including second guide information as an action to be output by the station device 240 by referring to the action table 250, 800, 950.

Technical features described above with reference to FIGS. 1 to 9 may be applied as is to FIGS. 10 to 15 and thus, repeated description is omitted.

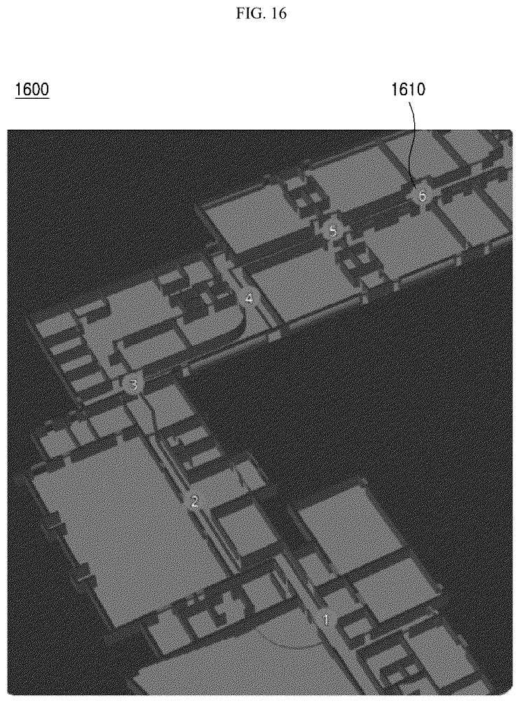

FIG. 16 illustrates a method of assigning a gun accident scenario to a shooter virtually placed in a 3D model of a separate space according to an example.

After the aforementioned simulation is completed or after the 3D model in which components are placed is constructed, the computer system may perform a verification simulation for verifying the 3D model in which the components are placed. The verification simulation may be performed before or after constructing the gun accident response guidance system in the actual separate space 110 (and utilizing the 3D model and the generated action table). As illustrated, for the verification simulation, a virtual shooter having a specific action scenario 1610 may be placed in a separate space 1600. The specific action scenario 1610 may be random. 1 to 6 may indicate shooting locations. Through the verification simulation, operation (i.e., action output, voice output, light emitting diode (LED) beam output) may be verified and the administrator may update the 3D model in which the components are placed by adjusting an erroneous placement or operation of a component. Therefore, the gun accident response guidance system to be constructed may be improved.

The verification simulation and the aforementioned simulation may be implemented to be displayed on an administrator terminal using virtual reality or augmented reality. Here, the administrator may verify the progress of the simulation from a first-person perspective (of the shooter or the user).

To perform the verification simulation, a virtual shooter for the verification simulation) is positioned on a specific position or node (or a random position or node) of the 3D model in which the nodes, the links, the hide space, etc. are designated. The virtual shooter has a specific action scenario in which the virtual shooter shoots at the specific shooting locations. The action scenario may be set by the computer system automatically and manually by the administrator. The verification simulation is performed based on the 3D model and the generated action table by simulating the actions of the virtual shooter on the 3D model. The computer system may update the 3D model and/or the action table based on the results of the verification simulation and/or based on the inputs of the administrator for the results of the verification simulation.

Technical features described above with reference to FIGS. 1 to 9 may be applied as is to FIGS. 10 to 15 and thus, repeated description is omitted.

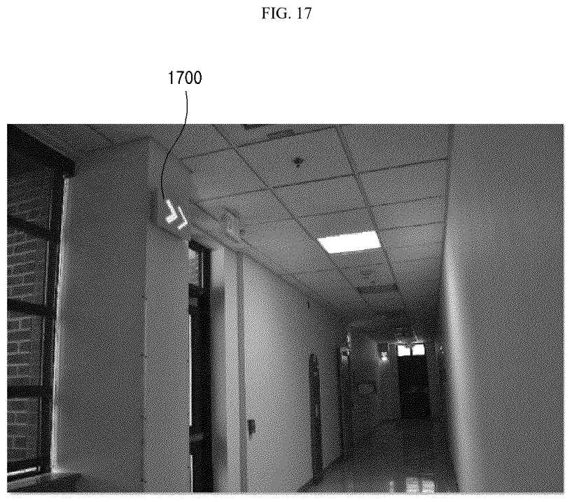

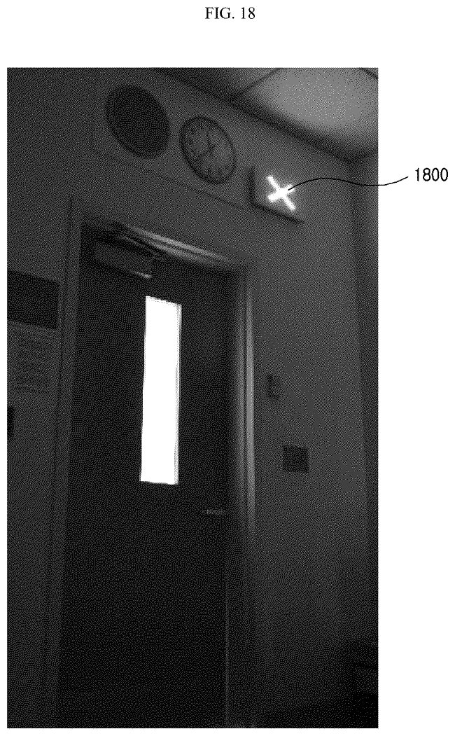

FIGS. 17 and 18 illustrate an operation of a station device when a gun accident occurs or during a training (i.e., drill) assuming the gun accident according to an example.

A station device 1700 is an example of a station device that outputs an indicator of evacuation order corresponding to the aforementioned first action.

A station device 1800 is an example of a station device that outputs an indicator corresponding to the aforementioned inactive action.

Situations shown in FIGS. 17 and 18 may represent an actual gun accident occurrence situation or an actual training (i.e., drill) situation conducted in a separate space.

Technical features described above with reference to FIGS. 1 to 16 may be applied as is to FIGS. 17 and 18 and thus, repeated description is omitted.

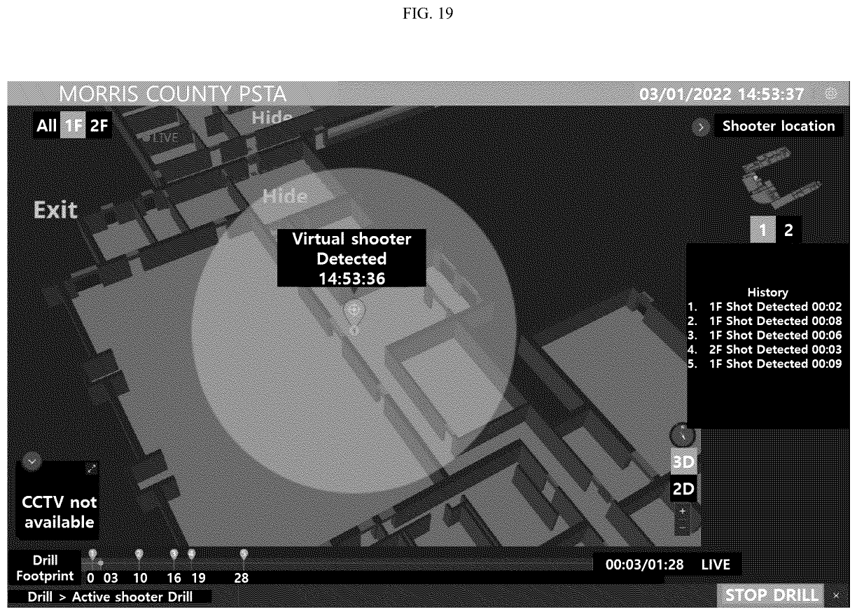

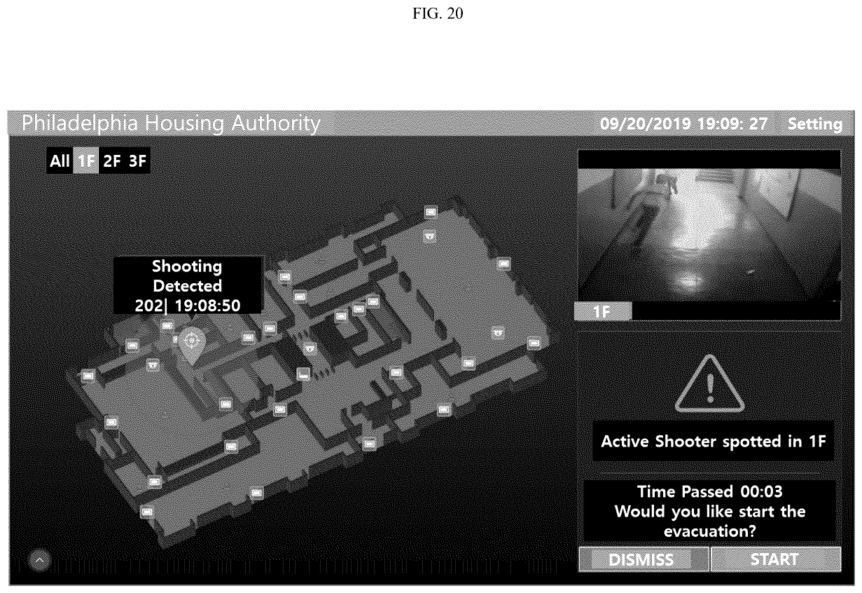

FIG. 19 illustrates a screen of an administrator terminal during a drill assuming a gun accident according to an example.

A screen of an administrator terminal may be, for example, a screen of the monitor 420 of FIG. 4.

FIG. 19 illustrates a screen of an administrator terminal when conducting a drill in an actual separate space. Detection history of shooting sound may be displayed on this screen, and a location of a shooter may be displayed on a 3D model of the separate space. On the 3D model, an action output status of each station device and an exit and a hide space of the separate space may also be displayed together.

The administrator may also suspend the drill by selecting a button on the screen.

Technical features described above with reference to FIGS. 1 to 18 may be applied as is to FIG. 19 and thus, repeated description is omitted.

FIG. 20 illustrates a screen of an administrator terminal when a gun accident occurs according to an example.

FIG. 20 illustrates a screen of an administrator terminal when a real gun accident occurs. The screen of the administrator terminal may be, for example, a screen of the monitor 420 of FIG. 4.

On the screen, a 3D model of a separate space may be displayed and a detection location (i.e., occurrence location of gun accident) of shooting sound and time may be displayed.

Meanwhile, when a detection result of the shooting sound is received by the server 210, the administrator may manually initiate an operation of the gun accident response guidance system. That is, as illustrated, in response to a selection on a start button, the server 210 may broadcast a detection location of the shooting sound (i.e., occurrence location of gun accident) to station devices. Here, a footage of a CCTV (i.e., a surveillance camera) placed at a location that is indicated by the detection result of the shooting sound may be automatically displayed and the administrator may verify whether the gun accident actually occurred through the footage of the CCTV. When the gun accident actually occurred, the administrator may initiate an operation of the gun accident response guidance system. That is, the server 210 may identify the CCTV at the location that is indicated by the detection result of the shooting sound and may display the footage of the identified CCTV on the screen of the administrator terminal. Also, the server 210 may control the CCTV such that a direction of the CCTV may move in a direction indicated by the detection result of the shooting sound. CCTV(s) may be disposed on the location(s) of the separate space independently of the station devices.

Alternatively, when the detection result of the shooting sound is received (or, when the detection result indicating a shooting sound with a predetermined magnitude or more is received), the server 210 may automatically initiate an operation of the gun accident response guidance system. Here, even without execution of the administrator, the server 210 may broadcast a detection location of the shooting sound (i.e., occurrence location of gun accident) to station devices.

Technical features described above with reference to FIGS. 1 to 19 may be applied as is to FIG. 20 and thus, repeated description is omitted.

The systems and/or apparatuses described herein may be implemented using hardware components, software components, and/or combination thereof. For example, apparatuses and components described herein may be implemented using one or more general-purpose or special purpose computers, such as, for example, a processor, a controller, an arithmetic logic unit (ALU), a digital signal processor, a microcomputer, a field programmable array (FPA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied permanently or temporarily in any type of machine, component, physical equipment, virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable storage mediums.

The methods according to the example embodiments may be recorded in non-transitory computer-readable media including program instructions to implement various operations embodied by a computer. Also, the media may include, alone or in combination with the program instructions, data files, data structures, and the like. Program instructions stored in the media may be those specially designed and constructed for the purposes, or they may be of the kind well-known and available to those having skill in the computer software arts. Examples of non-transitory computer-readable media include magnetic media such as hard disks, floppy disks, and magnetic tapes; optical media such as CD ROM disks and DVD; magneto-optical media such as floptical disks; and hardware devices that are specially to store and perform program instructions, such as read-only memory (ROM), random access memory (RAM), flash memory, and the like. Examples of program instructions include both machine code, such as produced by a compiler, and files containing higher level code that may be executed by the computer using an interpreter. The hardware device may be configured to operate as at least one software module to perform operations of the example embodiments, or vice versa.

While this disclosure includes specific example embodiments, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

1. A station device plurally provided to guide an action order responding to a gun accident to a user in a separate space, the station device comprising:
a microphone configured to detect a shooting sound in the separate space;
a communication unit configured to transmit a detection result of the shooting sound to a server and to receive, from the server, a first occurrence location of a first gun accident that is determined based on a detection result of a first shooting sound detected by a first station device in the separate space;
an action determination unit configured to determine an action to be output by the station device in response to the received first occurrence location using an action table in which an action to be output by the station device is mapped according to an occurrence location of a gun accident and a time; and
an action output unit configured to output the determined action,
wherein the action includes guide information for the user to prepare for the first gun accident, and
the action determination unit is configured to differently determine the action to be output by the station device over time by referring to the action table, and the action output unit is configured to output a different action over time,
wherein the action table is generated based on result of modeling movement and behavior of at least one virtual shooter at all positions within the separate space, and is generated, using an artificial intelligence algorithm, by learning an action to be output for the user located at any position within the separate space when the virtual shooter is positioned at any position within the separate space,
wherein the action table is generated by a method comprising the following operations and stored in the station device, and
the method comprises:
acquiring a three-dimensional (3D) map of the separate space;
specifying a plurality of nodes and a link that connects two of the nodes for the 3D map, at least one node among the nodes being specified as an exit node for the separate space and each station device among the plurality of station devices being associated with one of the nodes;
specifying at least one hide space within the 3D map;
placing the at least one virtual shooter in at least one node among the nodes and simulating a movement of the virtual shooter on the 3D map;
determining a first optimal route from a node corresponding to each station device to the exit node and a second optimal route from the node corresponding to each station device to the hide space; and
generating the action table based on a result of the simulation, the first optimal route, and the second optimal route, and
wherein the determining comprises
determining, using the artificial intelligence algorithm, the first optimal route and the second optimal route based on a learning result of an optimal action to be output for the user located at any position within the separate space when the virtual shooter is positioned at any location within the separate space by the simulation.

2. The station device of claim 1, wherein, by referring to the action table, the action determination unit is configured to,
when the station device is present within a possible escape location range for the separate space from the first occurrence location, determine a first action including first guide information for moving the user from a location of the station device to an exit location of the separate space as the action to be output by the station device, and
when the station device is present in a dangerous location range from the first occurrence location, determine a second action including second guide information for moving the user from the location of the station device to a hide space in the separate space as the action to be output by the station device.

3. The station device of claim 2, wherein, by referring to the action table, the action determination unit is configured to determine the second action as the action to be output by the station device over time after determining the first action as the action to be output by the station device, and
the action output unit is configured to output the second action over time after outputting the first action.

4. The station device of claim 1, wherein the action determination unit is configured to determine that the action output unit outputs an inactive action not including the guide information i) if a predetermined period of time elapses during which a shooter of the first gun accident is estimated to pass the location of the station device, or ii) if the first occurrence location is within a predetermined distance from the location of the station device.

5. The station device of claim 2, wherein, by referring to the action table, the action determination unit is configured to determine the second action including the second guide information as the action to be output by the station device when the station device is present at or around a line-of-sight (LoS) location associated with the first occurrence location, and
wherein the LoS is configured to include a position on an area of the separate space opened upward or downward from the first occurrence location, as determined based on the 3D map of the separate space.

6. The station device of claim 1, wherein, when the communication unit receives, from the server, a second occurrence location that is a location of a shooter of the first gun accident detected by a surveillance camera provided in the separate space, the action determination unit is configured to determine the action to be output by the station device in response to the second occurrence location using the action table.

7. The station device of claim 1, wherein the communication unit is configured to communicate with the server through a repeater provided in the separate space,
the server is a cloud server located outside the separate space, and
content including the guide information is provided to a terminal of the user based on communication between the communication unit and the server.

8. The station device of claim 1,
wherein the method further comprises:
placing a virtual shooter for verification configured to fire at a firing location according to a preset scenario on a 3D model in which the plurality of nodes, the link, and the hide space are designated on the 3D map;
performing a verification simulation on the 3D model by simulating a behavior of the virtual shooter for verification on the 3D model based on the 3D model and the generated action table; and
updating the 3D model based on an input from an administrator regarding a result of the verification simulation.

9. The station device of claim 1, wherein the simulating comprises determining a dangerous location range and a possible escape location range for the separate space on the 3D map based on a node corresponding to a location of the virtual shooter according to the movement.

10. The station device of claim 9, wherein the method further comprises specifying at least one LoS point within the 3D map that includes a position on the 3D map opened upward or downward from a node corresponding to a location of the virtual shooter, and
the determining the dangerous location range and the possible escape location range for the separate space comprises determining that a node or an arc on a LoS of the virtual shooter falls within the dangerous location range when the virtual shooter is located in the node associated with the LoS point.
